(19) United States
(12) Patent Application Publication
(10) Pub. No.: US 2007/0126526 A1
(43) Pub. Date: Jun. 7, 2007

(54) Input signal processing device, high-frequency component aqcuisition method, and low-frequency component acquisition method

(76) Inventors: Tuyosi Ataka, Gunma (JP); Yuji Yosino, Gunma (JP)

Correspondence Address: GREENBLUM & BERNSTEIN, P.L.C., 1950 ROLAND CLARKE PLACE, RESTON, VA, 20191, US

(21) Appl. No.: 10/556,351

(22) PCT Filed: May 12, 2004
(86) PCT No.: PCT/JP04/06708

§ 371 Date: Apr. 11, 2006

(30) Foreign Application Priority Data
May 14, 2003 (JP) 2003-136304

(51) Int. Cl. H01P 1/10

(52) U.S. Cl. 333/101

(57) ABSTRACT

It is possible to smoothly separate a signal according to the frequency band. An input signal processing device includes: an input signal terminal for receiving an input signal; a grounding capacitance element which is grounded; a grounding inductance element which is grounded; a connection inductance element for connecting the grounding capacitance element to the input signal terminal; a connection capacitance element for connecting the grounding inductance element to the input signal terminal; a first switch for selectively grounding a first intermediate portion between the connection inductance element and the grounding capacitance element; and a second switch for selectively grounding a second intermediate portion between the connection capacitance element and the grounding inductance element. When the first switch is turned ON, it is possible to acquire a high-frequency component from a high-frequency component output terminal. When the second switch is turned ON, it is possible to acquire a low-frequency component from a low-frequency component output terminal.

### TECHNICAL FIELD

The present invention relates to a separation of an input signal according to a frequency band.

### BACKGROUND ART

It has conventionally been practiced to separate an input signal according to a frequency band. Methods to separate the input signal include (i) a method using a switch and (ii) a method using a duplexer.

(i) Method by Means of Switch

This method employs a switch to lead the input signal to a low pass filter or a high pass filter, thereby separating the input signal. If a low-frequency (high-frequency) signal is to be acquired from the input signal, the input signal is led to the low-pass filter (high-pass filter). A coaxial switch or a semiconductor switch is generally used as the switch.

With reference to FIG. 10, an input signal terminal 102 is connected to a to a high-pass filter 106 by connecting between a terminal “a” and a terminal “b” of a switch 104. As a result, a high-frequency signal is acquired from an input signal. The input signal terminal 102 is connected to a low-pass filter 108 by connecting between the terminal “a” and a terminal “c” of the switch 104. As a result, a low-frequency signal is acquired from the input signal.

(ii) Method by Means of Duplexer

This method leads an input signal to a duplexer, which is a combination of a low-pass filter and a high-pass filter, and acquires a low-frequency signal and a high-frequency signal. This method is different from the method which employs the switch in that it is not necessary to switch the portion to which the input signal is led over to a low-pass filter or to a high-pass filter.

With reference to FIG. 11, the input signal terminal 102 is connected to a duplexer 110. The duplexer 110 includes a high-pass filter 112 and a low-pass filter 114. A component of the high-frequency signal in the input signal passes the high-pass filter 112. A component of the low-frequency signal in the input signal passes the low-pass filter 114.

FIG. 12(a) shows a gain-frequency characteristic (high-pass) 112a of the high-pass filter 112 and a gain-frequency characteristic (low-pass) 114a of the low-pass filter 114 in the duplexer 110. It should be noted that it is assumed that a cutoff frequency of the characteristic (low-pass) 114a is f1, and a cutoff frequency of the characteristic (high-pass) 112a is f2. For the sake of the illustration, the respective characteristics are represented as sequential lines which have corners at the cutoff frequencies. As shown in FIG. 12(a), it is required that f1<f2.

If f2<f1 as shown in FIG. 12(b), a signal within a band W (band between the cutoff frequencies) is influenced by both the high-pass filter and the low-pass filter, resulting in a malfunction.

It should be noted that Patent Document 1 (Japanese Laid-Open Patent Publication (Kokai) No. 2002-101005, ABSTRACT) describes a method to employ a duplexer to separate a signal.

However, the above-described methods to separate a signal pose the following problems. The method by means of a switch poses such problems that a mechanical switch such as a coaxial switch and an MEMS switch has large physical dimensions and the coaxial switch has a short life. A semiconductor switch poses such a problem that a distortion characteristic is inferior in a low-frequency area. If a duplexer is used, since a switch is not used, it is possible to eliminate the above problems. However, there is such a problem that a loss is large within the band W (f1 to f2, see FIG. 12(a)), resulting in a signal not being acquired.

A purpose of the present invention is to smoothly separate a signal according to a frequency band.

### DISCLOSURE OF THE INVENTION

According to the present invention as described in claim 1, an input signal processing device includes: an input signal terminal that receives an input signal; a connection inductance element that is connected to the input signal terminal at one end thereof, a connection capacitance element that is connected to the input signal terminal at one end thereof a first grounding switching unit that switches whether the other end of the connection inductance element is grounded or not; and a second grounding switching unit that switches whether the other end of the connection capacitance element is grounded or not.

According to the thus constructed invention, an input signal terminal receives an input signal. A connection inductance element is connected to the input signal terminal at one end thereof. A connection capacitance element is connected to the input signal terminal at one end thereof. A first grounding switching unit switches whether the other end of the connection inductance element is grounded or not. A second grounding switching unit switches whether the other end of the connection capacitance element is grounded or not.

According to the present invention as described in claim 2, the input signal processing device according to claim 1, further includes: a grounding capacitance element that is connected to the other end of the connection inductance element, and is grounded; and a grounding inductance element that is connected to the other end of the connection capacitance element, and is grounded.

The present invention as described in claim 3, is the input signal processing device according to claim 1 or 2, wherein at least one of the first grounding switching unit and the second grounding switching unit is a semiconductor switch or an MEMS switch.

According to the present invention as described in claim 4, a high-frequency component acquisition method that uses the input signal processing device according to any one of claims 1 to 3 to acquire a high-frequency component from the input signal, includes: a first intermediate portion grounding step of using the first grounding switching unit to ground the other end of the connection inductance element; and a second intermediate portion signal acquiring step of acquiring a signal output from the other end of the connection capacitance element.

According to the thus constructed invention, a high-frequency component acquisition method that uses the input signal processing device according to any one of claims 1 to 3 to acquire a high-frequency component from the input signal, is provided. The high-frequency component acquisition method includes a first intermediate portion grounding step and a second intermediate portion signal acquiring step. The first intermediate portion grounding step uses the first grounding switching unit to ground the other end of the connection inductance element. The second intermediate portion signal acquiring step acquires a signal output from the other end of the connection capacitance element.

According to the present invention as described in claim 5, a low-frequency component acquisition method that uses the input signal processing device according to any one of claims 1 to 3 to acquire a low-frequency component from the input signal, includes: a second intermediate portion grounding step of using the second grounding switching unit to ground the other end of the connection capacitance element; and a first intermediate portion signal acquiring step of acquiring a signal output from the other end of the connection inductance element.

According to the thus constructed invention, a low-frequency component acquisition method that uses the input signal processing device according to any one of claims 1 to 3 to acquire a low-frequency component from the input signal, is provided. The low-frequency component acquisition method includes a second intermediate portion grounding step and a first intermediate portion signal acquiring step. The second intermediate portion grounding step uses the second grounding switching unit to ground the other end of the connection capacitance element. The first intermediate portion signal acquiring step acquires a signal output from the other end of the connection inductance element.

### BRIEF DESCRIPTION OF THE DRAWINGS

FIG. 1 is a circuit diagram showing a configuration of an input signal processing device 1 according a first embodiment;

FIG. 2 is a flowchart showing the operation of the input signal processing device 1;

FIG. 3 shows a circuit configuration of the input signal processing device 1 if a first switch 52 is turned on;

FIG. 4(a) shows a gain-frequency characteristic when the input signal processing device 1 is used as a high-pass filter and FIG. 4(b) shows a gain-frequency characteristic when the input signal processing device 1 is used as a low-pass filter;

FIG. 5 shows a circuit configuration of the input signal processing device 1 if a second switch 54 is turned on;

FIG. 6 is a circuit diagram showing a configuration of an input signal processing device 1 according a second embodiment;

FIG. 7 shows a circuit configuration of the input signal processing device 1 if a first switch 52 is turned on;

FIG. 8(a) shows a gain-frequency characteristic when the input signal processing device 1 is used as a high-pass filter and FIG. 8(b) shows a gain-frequency characteristic when the input signal processing device 1 is used as a low-pass filter;

FIG. 9 shows a circuit configuration of the input signal processing device 1 if a second switch 54 is turned on;

FIG. 10 is a diagram showing a configuration of a circuit which separates an input signal according to a frequency band by means of a switch according to prior art;

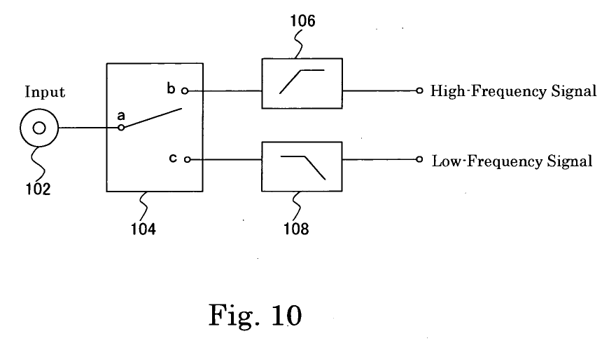

FIG. 11 is a diagram showing a configuration of a circuit which separates an input signal according to a frequency band by means of a duplexer according to prior art; and

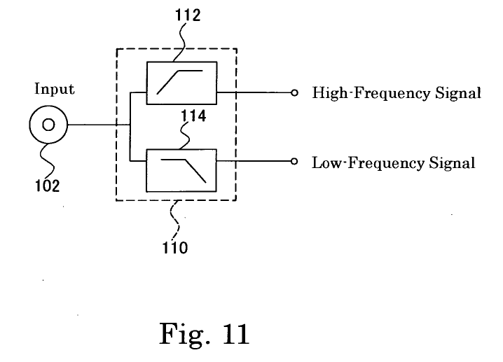

FIG. 12(a) and FIG. 12(b) are charts showing a gain-frequency characteristic (high-pass) 112a of a high-pass filter 112 and a gain-frequency characteristic (low-pass) 114a of a low-pass filter 114 in the duplexer 110 according to the prior art, in which FIG. 12(a) shows a normal state, and FIG. 12(b) shows an abnormal state.

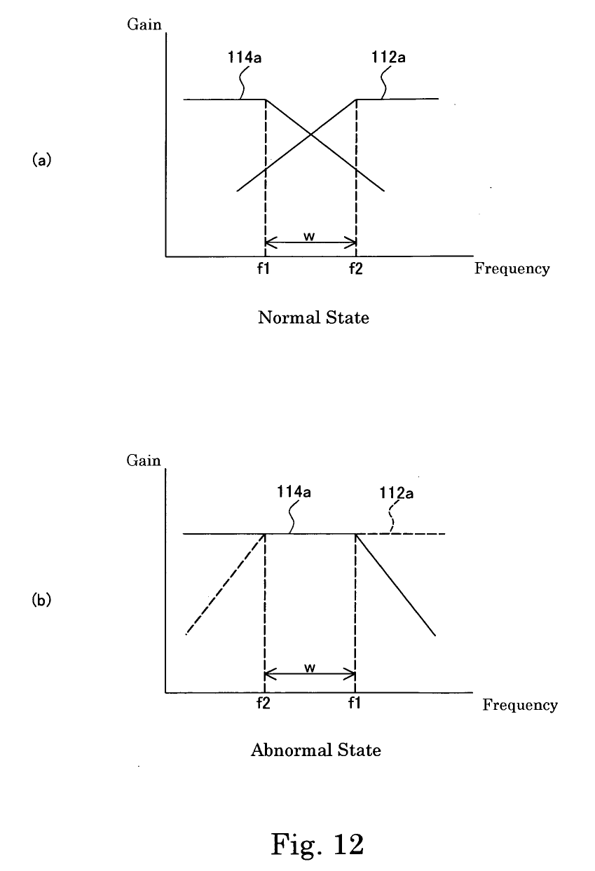

### BEST MODE FOR CARRYING OUT THE INVENTION

A description will now be given of embodiments of the present invention with reference to drawings.

### First Embodiment

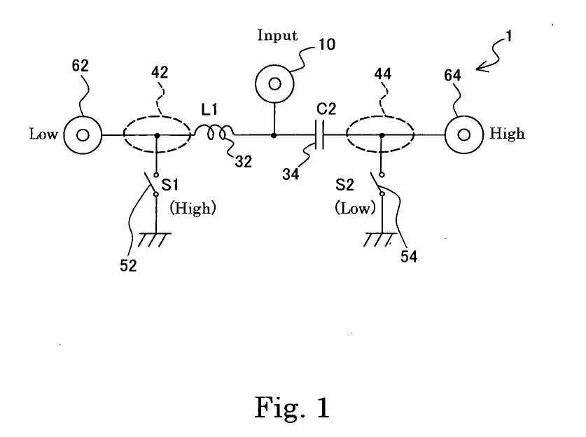

FIG. 1 is a circuit diagram showing a configuration of an input signal processing device 1 according a first embodiment of the present invention. The input signal processing device 1 is provided with an input signal terminal 10, a connection inductance element 32, a connection capacitance element 34, a first intermediate portion 42, a second intermediate portion 44, a first switch (first grounding switching means) 52, a second switch (second grounding switching means) 54, a low-frequency component output terminal 62, and a high-frequency component output terminal 64.

The input signal terminal 10 serves as a terminal to receive an input signal. The input signal contains a high-frequency component and a low-frequency component.

The connection inductance element 32 is connected to the input signal terminal 10 at one end thereof. It should be noted that it is assumed that the inductance of the connection inductance element 32 is L1.

The connection capacitance element 34 is connected to the input signal terminal 10 at one end thereof. It should be noted that it is assumed that the capacitance of the connection capacitance element 34 is C2.

The first intermediate portion 42 is connected to the other end of the connection inductance element 32, and is an intermediate portion between the connection inductance element 32 and the low-frequency component output terminal 62.

The second intermediate portion 44 is connected to the other end of the connection capacitance element 34, and is an intermediate portion between the connection capacitance element 34 and the high-frequency component output terminal 64.

The first switch (first grounding switching means) 52 is a switch used to switch whether the first intermediate portion 42 is grounded or not. If the switch is turned on, the first intermediate portion 42 is grounded. If the switch is turned off, the first intermediate portion 42 is not grounded. It should be noted that if the first intermediate portion 42 is grounded, the other end of the connection inductance element 32 will be grounded.

The second switch (second grounding switching means) 54 is a switch used to switch whether the second intermediate portion 44 is grounded or not. If the switch is turned on, the second intermediate portion 44 is grounded. If the switch is turned off, the second intermediate portion 44 is not grounded. It should be noted that if the second intermediate portion 44 is grounded, the other end of the connection capacitance element 34 will be grounded.

It should be noted that the first switch 52 and the second switch 54 may be semiconductor switches (such as PIN diodes or field effect transistors (FETs)). Namely, they may be switches with an inferior distortion characteristic in a low-frequency area such as a semiconductor switch.

The low-frequency component output terminal 62 is connected to the first intermediate portion 42, and is used as a terminal to acquire a signal output from the first intermediate portion 42.

The high-frequency component output terminal 64 is connected to the second intermediate portion 44, and is used as a terminal to acquire a signal output from the second intermediate portion 44.

A description will now be given of an operation of the first embodiment.

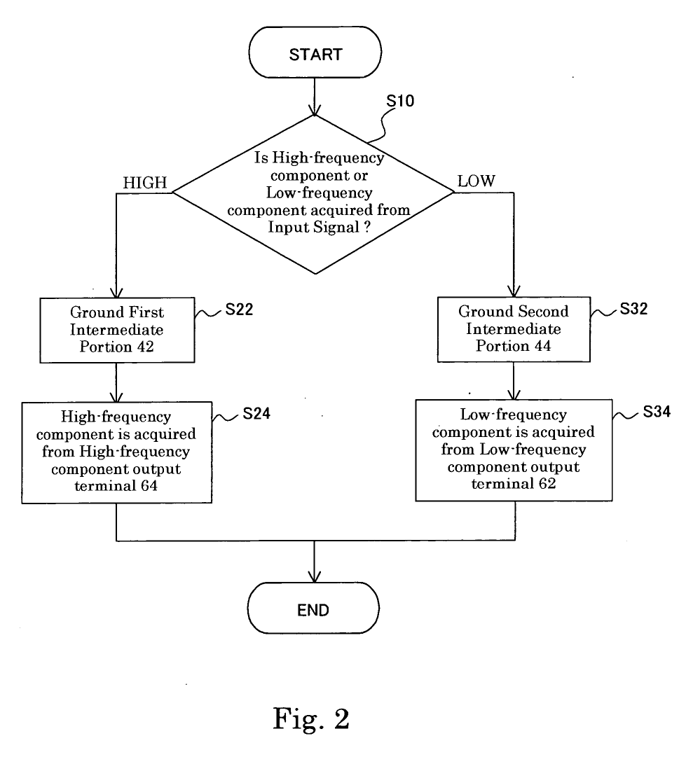

The input signal processing device 1 is to be used to acquire the high-frequency component or the low-frequency component from the input signal. FIG. 2 is a flowchart showing the operation of the input signal processing device 1.

First, the input signal processing device 1 is used to determine whether the high-frequency component or the low-frequency component is acquired from the input signal (S10). It should be noted that both the first switch 52 and the second switch 54 are temporarily turned off on this occasion.

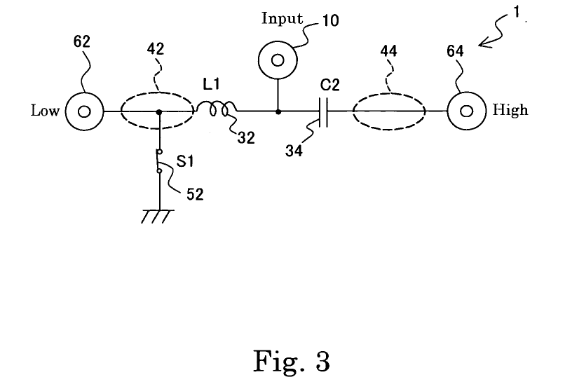

If the high-frequency component is to be acquired from the input signal (“HIGH” in S10), the first switch 52 is turned on to ground the first intermediate portion 42 (S22). FIG. 3 shows a circuit configuration if the first switch 52 is turned on. It should be noted that the second switch 54 is turned off, thus does not specifically function, and is not shown.

The impedance of the connection capacitance element 34 (capacitance: C2) is represented as 1/(2πf·C2) where f denotes a frequency. The impedance of the connection capacitance element 34 is thus low for a high frequency. On the other hand, the impedance of the connection inductance element 32 (inductance: L1) is represented as 2πf·L1 where f denotes a frequency. The impedance of the connection inductance element 32 is thus high for a high frequency. The high-frequency component in the input signal thus passes the connection capacitance element 34 with the low impedance, and reaches the high-frequency component output terminal 64. On the other hand, the high-frequency component in the input signal hardly passes the connection inductance element 32 with the high impedance. It is thus possible to reduce the high-frequency component in the input signal which does not reach the high-frequency component output terminal 64.

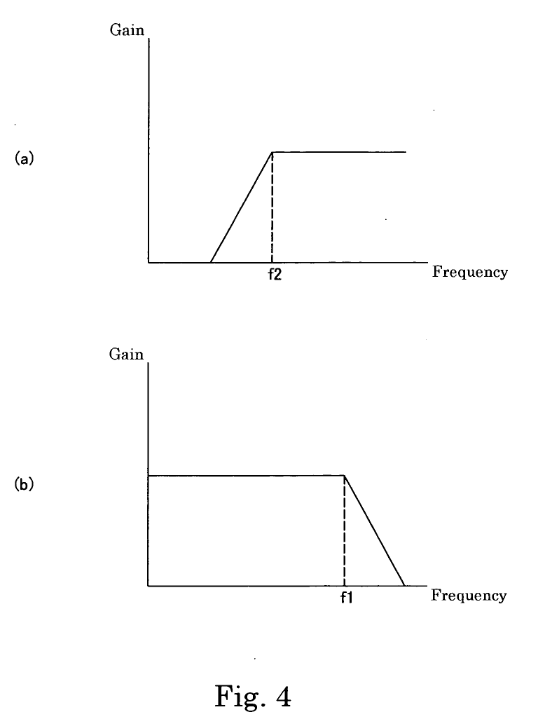

In this way, the input signal processing device 1 functions as a high-pass filter. FIG. 4(a) shows a gain-frequency characteristic on this occasion. It is assumed that a cutoff frequency is f2. For the sake of the illustration, the characteristic is represented as a sequential line which has a corner at the cutoff frequency. The gain is almost constant for a high-frequency component higher than the cutoff frequency f2, and such a high-frequency component can pass the input signal processing device 1. The gain is small for a frequency component lower than the cut-off frequency f2, and such a frequency component cannot pass the input signal processing device 1.

As described later, the low-frequency component output terminal 62 is used to acquire the low-frequency component in the input signal, and it is thus not preferable that the high-frequency component in the input signal is output therefrom. On this occasion, since the first switch 52 is turned on, the high-frequency component which has passed the connection inductance element 32 is directed to the first switch 52. As a result, the low-frequency component output terminal 62 hardly outputs the high-frequency component. Namely, the low-frequency component output terminal 62 is isolated.

With reference to FIG. 2 again, the high-frequency component in the input signal reaches the high-frequency component output terminal 64, and the high-frequency component is acquired from the high-frequency component output terminal 64 (S24).

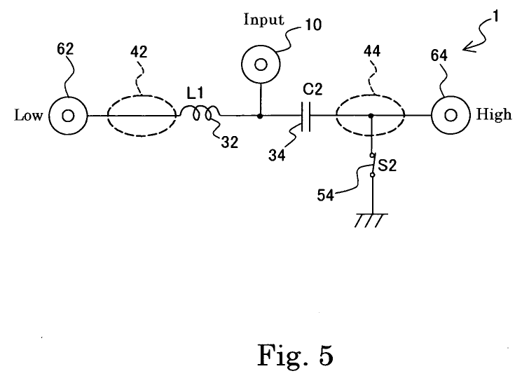

If the low-frequency component is to be acquired from the input signal (“LOW” in S10), the second switch 54 is turned on to ground the second intermediate portion 44 (S32). FIG. 5 shows a circuit configuration if the second switch 54 is turned on. It should be noted that the first switch 52 is turned off, thus does not specifically function, and is not shown.

The impedance of the connection inductance element 32 (inductance: L1) is represented as 2πf·L1 where f denotes a frequency. The impedance of the connection inductance element 32 is thus low for a low frequency. On the other hand, the impedance of the connection capacitance element 34 (capacitance: C2) is represented as 1/(2πf·C2) where f denotes a frequency. The impedance of the connection capacitance element 34 is thus high for a low frequency. The low-frequency component in the input signal thus passes the connection inductance element 32 with the low impedance, and reaches the low-frequency component output terminal 62. On the other hand, the low-frequency component in the input signal hardly passes the connection capacitance element 34 with the high impedance. It is thus possible to reduce the low-frequency component in the input signal which does not reach the low-frequency component output terminal 62.

In this way, the input signal processing device 1 functions as a low-pass filter. FIG. 4(b) shows a gain-frequency characteristic on this occasion. It is assumed that a cutoff frequency is f1. For the sake of the illustration, the characteristic is represented as a sequential line which has a corner at the cutoff frequency. The gain is almost constant for a low-frequency component lower than the cutoff frequency f1, and such a low-frequency component can pass the input signal processing device 1. The gain is small for a frequency component higher than the cut-off frequency f1, and such a frequency component cannot pass the input signal processing device 1.

The high-frequency component output terminal 64 is used to acquire the high-frequency component in the input signal, and it is thus not preferable that the low-frequency component in the input signal is output therefrom. On this occasion, since the second switch 54 is turned on, the low-frequency component which has passed the connection capacitance element 34 is directed to the second switch 54. As a result, the high-frequency component output terminal 64 hardly outputs the low-frequency component. Namely, the high-frequency component output terminal 64 is isolated.

It is clear that f1>f2 from a comparison between FIG. 4(a) and FIG. 4(b). If a duplexer is employed, a malfunction occurs upon f1>f2. However, according to the embodiment of the present invention, since the low-frequency component output terminal 62 is isolated when the high-frequency component is acquired, and the high-frequency component output terminal 64 is isolated when the low-frequency component is acquired. A malfunction thus does not occur even upon f1>f2.

A detailed description will now be given of the reason for f1>f2. If the high-frequency component is to be acquired, the circuit is configured as shown in FIG. 3, and if the low-frequency component is to be acquired, the circuit is configured as shown in FIG. 5. If the circuits shown in FIG. 3 and FIG. 5 are considered as a three-element Butterworth filter, C2 and L1 are represented as described below. It should be noted that equations (1) and (2) are derived from the circuit shown in FIG. 5. Equations (3) and (4) are derived from the circuit shown in FIG. 3.

$$\begin{matrix}[ EQU . 1 ] & \\ C 2 = \frac{\sqrt{2}}{2 π f 1 \times Z} & ( 1 ) \\ L 1 = \frac{\sqrt{2} \times Z}{2 π f 1} & ( 2 ) \\ C 2 = \frac{1 / \sqrt{2}}{2 π f 2 \times Z} & ( 3 ) \\ L 1 = \frac{Z / \sqrt{2}}{2 π f 2} & ( 4 )\end{matrix}$$

It should be noted that Z denotes a characteristic impedance of the filter. It is understandable that f1=2×f2 according to the equations (1) and (3) (or the equations (2) and (4)). Namely the condition of f1>f2 is satisfied.

With reference to FIG. 2 again, the low-frequency component in the input signal reaches the low-frequency output terminal 62, and the low-frequency component is acquired from the low-frequency component output terminal 62 (S34).

It should be noted that if the second switch 54 is turned on (the first switch 52 is turned off), since the impedance of the connection capacitance element 34 (capacitance: C2) is represented as 1/(2πf·C2) where f denotes a frequency, the impedance is high in a low-frequency area. The low-frequency component in the input signal is attenuated while passing the connection capacitance element 34 with a high impedance, and a small quantity of the low-frequency component reaches the second switch 54. A distortion generated by the second switch 54 is thus also small. As a result, even if there is used a switch with an inferior distortion characteristic within a low-frequency area such as a semiconductor switch as the second switch 54, there is a small adverse-effect upon the low-frequency component acquired from the low-frequency component output terminal 62. Moreover, since the first switch 52 is turned off, there is no influence especially on the low-frequency component.

Moreover, an MEMS switch is a type of a mechanical switch, and the life thereof is relatively longer than a coaxial switch. However dimensions thereof are large, the MEMS switch is considered as an inductor upon contacts are closed, and is considered as an open stub upon the contacts are open, and thus presents an inferior high-frequency characteristic. However, even if the MEMS switch is used as the first switch 52, there is a small adverse-effect upon the high-frequency component acquired from the high-frequency component output terminal 64. If the first switch 52 is turned on (the second switch 54 is turned off), since the impedance of the connection inductance element 32 inductance: L1) is represented as 2πf·L1 where f denotes a frequency, the impedance is high in a high-frequency area. The high-frequency component in the input signal is attenuated while passing the connection inductance element 32 with a high impedance, and a small quantity of the high-frequency component reaches the first switch 52. A distortion generated by the first switch 52 is thus also small. Consequently, even if the MEMS switch is used as the first switch 52, there is a small adverse-effect upon the high-frequency component acquired from the high-frequency component output terminal 64.

According to the first embodiment, if the first switch 52 is turned on while receiving an input signal from the input signal terminal 10, a high-frequency component of the input signal can be acquired from the high-frequency component output terminal 64. On this occasion, if the second switch 54 is turned on, the low-frequency component of the input signal is acquired from the low-frequency component output terminal 62.

If the first switch 52 is turned on, it is possible to isolate the low-frequency component output terminal 62, and if the second switch 54 is turned on, it is possible to isolate the high-frequency component output terminal 64.

As a result, upon the input signal processing device 1, the relationship of f1>f2 between the cutoff frequency f1 upon being used as a low-pass filter and the cutoff frequency f2 upon being used as a high-pass filter pauses no problem. As a result, it is not difficult to acquire the input signal corresponding to a frequency within a band from f2 to f1 due to attenuation.

Moreover, even if there are used switches with an inferior distortion characteristic within a low-frequency area such as a semiconductor switch as the first switch 52 and the second switch 54, there is a small adverse-effect upon the low-frequency component acquired from the low-frequency component output terminal 62.

### Second Embodiment

The second embodiment is different from the first embodiment in that a grounding capacitance element 22, which is grounded, is connected to the first intermediate portion 42, and a grounding inductance element 24, which is grounded, is connected to the second intermediate portion 44.

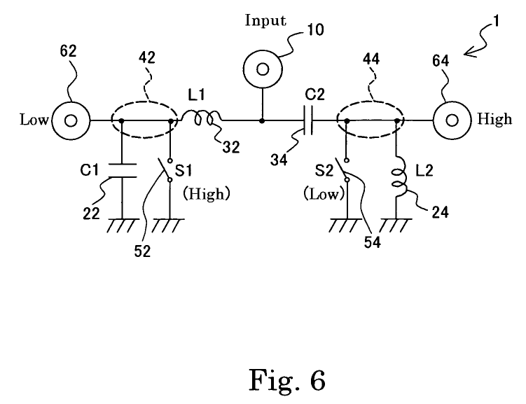

FIG. 6 is a circuit diagram showing a configuration of the input signal processing device 1 according the second embodiment of the present invention. The input signal processing device 1 is provided with the input signal terminal 10, the grounding capacitance element 22, the grounding inductance element 24, the connection inductance element 32, the connection capacitance element 34, the first intermediate portion 42, the second intermediate portion 44, the first switch (first grounding switching means) 52, the second switch (second grounding switching means) 54, the low-frequency component output terminal 62, and the high-frequency component output terminal 64. In the following section, like components are denoted by like numerals as of the first embodiment and will be explained in no more details.

The input signal terminal 10, the connection inductance element 32, the connection capacitance element 34, the first intermediate portion 42, the second intermediate portion 44, the first switch (first grounding switching means) 52, the second switch (second grounding switching means) 54, the low-frequency component output terminal 62, and the high-frequency component output terminal 64 are similar to those in the first embodiment, and will be explained in no more details.

The grounding capacitance element 22 is grounded. It should be noted that it is assumed that the capacitance of the grounding capacitance element 22 is C1. Moreover, the grounding capacitance element 22 is connected to the first intermediate portion 42. It is thus the grounding capacitance element 22 is to be connected to the other end of the connection inductance element 32. Further, the grounding capacitance element 22 is arranged closer to the low-frequency component output terminal 62 than the first switch 52.

The grounding inductance element 24 is grounded. It should be noted that it is assumed that the inductance of the grounding inductance element 24 is L2. Moreover, the grounding inductance element 24 is connected to the second intermediate portion 44. It is thus the grounding inductance element 24 is to be connected to the other end of the connection capacitance element 34. Further, the grounding inductance element 24 is arranged closer to the high-frequency component output terminal 64 than the second switch 54.

A description will now be given of an operation of the second embodiment.

The input signal processing device 1 is to be used to acquire a high-frequency component or a low-frequency component from the input signal. FIG. 2 is a flowchart showing the operation of the input signal processing device 1.

First, the input signal processing device 1 is used to determine whether the high-frequency component or the low-frequency component is acquired from the input signal (S10). It should be noted that both the first switch 52 and the second switch 54 are temporarily turned off.

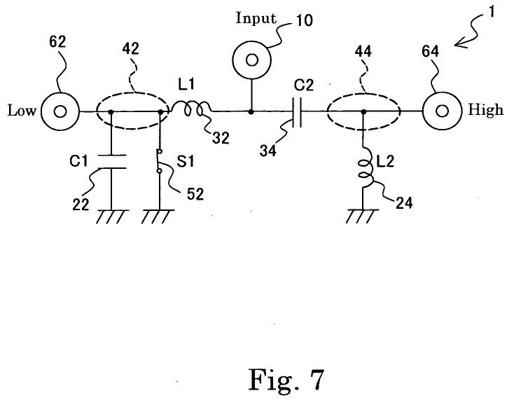

On this occasion, if the high-frequency component is to be acquired from the input signal (“HIGH” in S10), the first switch 52 is turned on to ground the first intermediate portion 42 (S22). FIG. 7 shows a circuit configuration if the second switch 52 is turned on. It should be noted that the second switch 54 is turned off, thus does not specifically function, and is not shown.

The impedance of the connection capacitance element 34 (capacitance: C2) is represented as 1/(2πf·C2) where f denotes a frequency. The impedance of the connection capacitance element 34 is thus low for a high frequency. On the other hand, the impedances of the grounding inductance element 24 (inductance: L2) and the connection inductance element 32 (inductance: L1) are represented respectively as 2πf·L2 and 2πf·L1 where f denotes a frequency. The impedances of the grounding inductance element 24 and the connection inductance element 32 are thus high for a high frequency. The high-frequency component in the input signal thus passes the connection capacitance element 34 with a low impedance, and reaches the high-frequency component output terminal 64. On the other hand, the high-frequency component in the input signal hardly passes the grounding inductance element 24 and the connection inductance element 32 with the high impedance. It is thus possible to reduce the high-frequency component in the input signal which does not reach the high-frequency component output terminal 64.

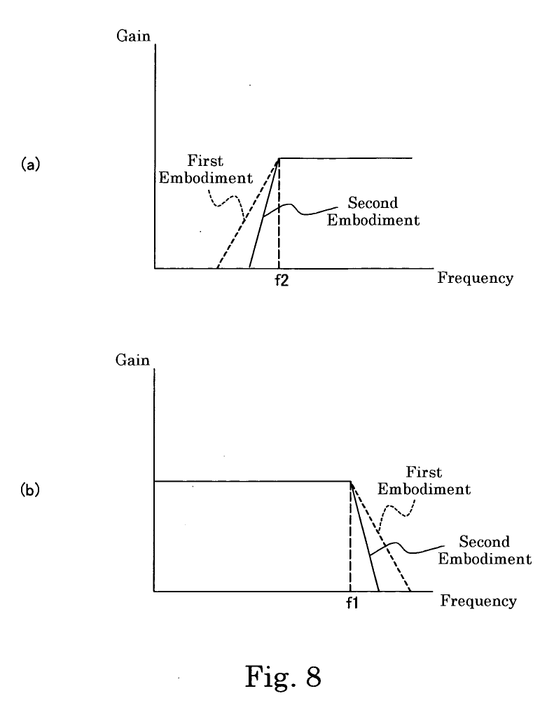

In this way, the input signal processing device 1 functions as a high-pass filter. FIG. 8(a) shows a gain-frequency characteristic on this occasion. It is assumed that a cutoff frequency is f2. For the sake of the illustration, the characteristic is represented as a sequential line which has a corner at the cutoff frequency. The gain is almost constant for a high-frequency component higher than the cutoff frequency f2, and such a high-frequency component can pass the input signal processing device 1. The gain is small for a frequency component lower than the cut-off frequency f2, and such a frequency component cannot pass the input signal processing device 1.

It should be noted, as shown in FIG. 8(a), the gain decreases more rapidly as the frequency decreases for the frequency component lower than the cut-off frequency f2 in the second embodiment (refer to FIG. 7) than the first embodiment (refer to FIG. 3). This is brought about by an effect of adding the grounding inductance element 24.

As described later, the low-frequency component output terminal 62 is used to acquire the low-frequency component in the input signal, and it is thus not preferable that the high-frequency component in the input signal is output therefrom. On this occasion, since the first switch 52 is turned on, the high-frequency component which has passed the connection inductance element 32 is directed to the first switch 52. As a result, the low-frequency component output terminal 62 hardly outputs the high-frequency component. Namely, the low-frequency component output terminal 62 is isolated.

With reference to FIG. 2 again, the high-frequency component in the input signal reaches the high-frequency output terminal 64, and the high-frequency component is acquired from the high-frequency output terminal 64 (S24).

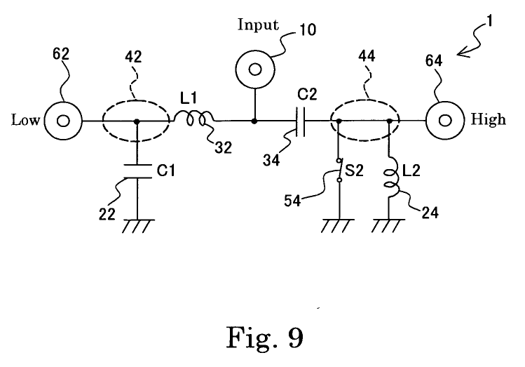

If the low-frequency component is to be acquired from the input signal (“LOW” in S10), the second switch 54 is turned on to ground the second intermediate portion 44 (S32). FIG. 9 shows a circuit configuration if the second switch 54 is turned on. It should be noted that the first switch 52 is turned off, thus does not specifically function, and is not shown.

The impedance of the connection inductance element 32 (inductance: L1) is represented as 2πf·L1 where f denotes a frequency. The impedance of the connection inductance element 32 is thus low for a low frequency. On the other hand, the impedances of the connection capacitance element 34 (capacitance: C2) and the grounding capacitance element 22 (capacitance: C1) are represented respectively as 1/(2πf·C2) and 1/(2πf·C1) where f denotes a frequency. The impedances of the connection capacitance element 34 and the grounding capacitance element 22 are thus high for a low frequency. The low-frequency component in the input signal thus passes the connection inductance element 32 with the low impedance, and reaches the low-frequency component output terminal 62. On the other hand, the low-frequency component in the input signal hardly passes the connection capacitance element 34 and the grounding capacitance element 22 with the high impedances. It is thus possible to reduce the low-frequency component in the input signal which does not reach the low-frequency component output terminal 62.

In this way, the input signal processing device 1 functions as a low-pass filter. FIG. 8(b) shows a gain-frequency characteristic on this occasion. It is assumed that a cutoff frequency is f1. For the sake of the illustration, the characteristic is represented as a sequential line which has a corner at the cutoff frequency. The gain is almost constant for a low-frequency component lower than the cutoff frequency f1, and such a low-frequency component can pass the input signal processing device 1. The gain is small for a frequency component higher than the cut-off frequency f1, and such a frequency component cannot pass the input signal processing device 1.

It should be noted, as shown in FIG. 8(b), the gain decreases more rapidly as the frequency increases for the frequency component higher than the cut-off frequency f1 in the second embodiment (refer to FIG. 9) than the first embodiment (refer to FIG. 5). This is brought about by an effect of adding the grounding capacitance element 22.

The high-frequency component output terminal 64 is used to acquire the high-frequency component in the input signal, and it is thus not preferable that the low-frequency component in the input signal is output therefrom. On this occasion, since the second switch 54 is turned on, the low-frequency component which has passed the connection capacitance element 34 is directed to the second switch 54. As a result, the high-frequency component output terminal 64 hardly outputs the low-frequency component. Namely, the high-frequency component output terminal 64 is isolated.

It is clear that f1>f2 from a comparison between FIG. 8(a) and FIG. 8(b). If a duplexer is employed, a malfunction occurs upon f1>f2. However, according to the embodiment of the present invention, since the low-frequency component output terminal 62 is isolated when the high-frequency component is acquired, and the high-frequency component output terminal 64 is isolated when the low-frequency component is acquired. A malfunction thus does not occur upon f1>f2.

A detailed description will now be given of a reason for f1>f2. If the high-frequency component is acquired, the circuit is configured as shown in FIG. 7, and if the low-frequency component is acquired, the circuit is configured as shown in FIG. 9. On this occasion, the grounding capacitance element 22 (capacitance: C1) is neglected in FIG. 7, and the grounding inductance element 24 (inductance: L2) is neglected in FIG. 9. If the circuits shown in FIG. 7 and FIG. 9 are considered as a three-element Butterworth filter, C1, L1, C2, and L2 are represented as described below.

$$\begin{matrix}[ EQU . 2 ] & \\ C 1 = C 2 = \frac{1}{2 π f 1 \times Z} & ( 11 ) \\ L 1 = \frac{2 \times Z}{2 π f 1} & ( 12 ) \\ C 2 = \frac{1 / 2}{2 π f 2 \times Z} & ( 13 ) \\ L 1 = L 2 = \frac{Z}{2 π f 2} & ( 14 )\end{matrix}$$

It should be noted that Z denotes a characteristic impedance of the filter. Moreover, it is assumed that C1=C2, and L1=L2. It is understandable that f1=2×f2 according to the equations (11) and (13) (or the equations (12) and (14)). Namely the condition of f1>f2 is satisfied.

With reference to FIG. 2 again, the low-frequency component in the input signal reaches the low-frequency component output terminal 62, and the low-frequency component is acquired from the low-frequency component output terminal 62 (S34).

It should be noted that if the second switch 54 is turned on (the first switch 52 is turned off), since the impedance of the connection capacitance element 34 (capacitance: C2) is represented as 1/(2πf·C2) where f denotes a frequency, the impedance is high in a low-frequency area. The low-frequency component in the input signal is attenuated while passing the connection capacitance element 34 with a high impedance, and a small quantity of the low-frequency component reaches the second switch 54. A distortion generated by the second switch 54 is thus also small. As a result, even if there is used a switch with an inferior distortion characteristic within a low-frequency area such as a semiconductor switch as the second switch 54, there is a small adverse-effect upon the low-frequency component acquirable from the low-frequency component output terminal 62. Moreover, since the first switch 52 is turned off, there is no influence especially on the low-frequency component.

Moreover, an MEMS switch is a type of a mechanical switch, and the life thereof is relatively longer than a coaxial switch. However dimensions thereof are large, the MEMS switch is considered as an inductor upon contacts are closed, and is considered as an open stub upon the contacts are open, and thus presents an inferior high-frequency characteristic. However, even if the MEMS switch is used as the first switch 52, there is a small adverse-effect upon the high-frequency component acquired from the high-frequency component output terminal 64. If the first switch 52 is turned on (the second switch 54 is turned off), since the impedance of the connection inductance element 32 (inductance: L1) is represented as 2πf·L1 where f denotes a frequency, the impedance is high in a high-frequency area. The high-frequency component in the input signal is attenuated while passing the connection inductance element 32 with a high impedance, and a small quantity of the high-frequency component reaches the first switch 52. A distortion generated by the first switch 52 is thus also small. Consequently, even if the MEMS switch is used as the first switch 52, there is a small adverse-effect upon the high-frequency component acquired from the high-frequency component output terminal 64.

According to the second embodiment, there are obtained effects as in the first embodiment. Moreover, the second embodiment cuts off a component lower than the cutoff frequency f2 (higher than f1) better than the first embodiment while functioning as a high-pass filter (low-pass filter).

1. An input signal processing device comprising:
an input signal terminal that receives an input signal;
a connection inductance element connected to said input signal terminal at one end thereof;
a connection capacitance element connected to said input signal terminal at one end thereof;
a first grounding switching means that selectively grounds an other end of said connection inductance element; and
a second grounding switching means that selectively grounds an other end of said connection capacitance element.

2. The input signal processing device according to claim 1, further comprising:
a grounding capacitance element that is connected to the other end of said connection inductance element, and is grounded; and
a grounding inductance element that is connected to the other end of said connection capacitance element, and is grounded.

3. The input signal processing device according to claim 1, wherein at least one of said first grounding switching means and said second grounding switching means is a semiconductor switch or an MEMS switch.

4. A high-frequency component acquisition method that uses the input signal processing device according to claim 1 to acquire a high-frequency component from the input signal, comprising:
a first intermediate portion grounding step of using said first grounding switching means to ground the other end of said connection inductance element; and
a second intermediate portion signal acquiring step of acquiring a signal output from the other end of said connection capacitance element.

5. A low-frequency component acquisition method that uses the input signal processing device according to claim 1 to acquire a low-frequency component from said input signal, comprising:
a second intermediate portion grounding step of using said second grounding switching means to ground the other end of said connection capacitance element; and
a first intermediate portion signal acquiring step of acquiring a signal output from the other end of said connection inductance element.

6. The input signal processing device according to claim 2, wherein at least one of said first grounding switching means and said second grounding switching means is a semiconductor switch or an MEMS switch.

7. A high-frequency component acquisition method that uses the input signal processing device according to claim 2 to acquire a high-frequency component from the input signal, comprising:
a first intermediate portion grounding step of using said first grounding switching means to ground the other end of said connection inductance element; and
a second intermediate portion signal acquiring step of acquiring a signal output from the other end of said connection capacitance element.

8. A high-frequency component acquisition method that uses the input signal processing device according to claim 3 to acquire a high-frequency component from the input signal, comprising:
a first intermediate portion grounding step of using said first grounding switching means to ground the other end of said connection inductance element; and
a second intermediate portion signal acquiring step of acquiring a signal output from the other end of said connection capacitance element.

9. A high-frequency component acquisition method that uses the input signal processing device according to claim 6 to acquire a high-frequency component from the input signal, comprising:
a first intermediate portion grounding step of using said first grounding switching means to ground the other end of said connection inductance element; and
a second intermediate portion signal acquiring step of acquiring a signal output from the other end of said connection capacitance element.

10. A low-frequency component acquisition method that uses the input signal processing device according to claim 2 to acquire a low-frequency component from said input signal, comprising:
a second intermediate portion grounding step of using said second grounding switching means to ground the other end of said connection capacitance element; and
a first intermediate portion signal acquiring step of acquiring a signal output from the other end of said connection inductance element.

11. A low-frequency component acquisition method that uses the input signal processing device according to claim 3 to acquire a low-frequency component from said input signal, comprising:
a second intermediate portion grounding step of using said second grounding switching means to ground the other end of said connection capacitance element; and
a first intermediate portion signal acquiring step of acquiring a signal output from the other end of said connection inductance element.

12. A low-frequency component acquisition method that uses the input signal processing device according to claim 6 to acquire a low-frequency component from said input signal, comprising:
a second intermediate portion grounding step of using said second grounding switching means to ground the other end of said connection capacitance element; and
a first intermediate portion signal acquiring step of acquiring a signal output from the other end of said connection inductance element.

13. An input signal processing device, comprising:
an input signal terminal that receives an input signal;
a connection inductance element connected to said input signal terminal at one end thereof;
a connection capacitance element connected to said input signal terminal at one end thereof;
a first grounding switch that selectively grounds an other end of said connection inductance element and
a second grounding switch that selectively grounds an other end of said connection capacitance element.

14. The input signal processing device according to claim 13, further comprising:
a grounding capacitance element connected to the other end of said connection inductance element, and is grounded; and
a grounding inductance element connected to the other end of said connection capacitance element, and is grounded.

15. The input signal processing device according to claim 13, wherein at least one of said first grounding switch and said second grounding switch comprises one of a semiconductor switch and a MEMS switch.

16. A high-frequency component acquisition method that uses the input signal processing device according to claim 13 to acquire a high-frequency component from the input signal, comprising:
using said first grounding switch to selectively ground an other end of the connection inductance element; and
acquiring a signal output from the other end of the connection capacitance element.

17. A low-frequency component acquisition method that uses the input signal processing device according to claim 13 to acquire a low-frequency component from said input signal, comprising:
using said second grounding switch to selectively ground an other end of the connection capacitance element; and
acquiring a signal output from the other end of the connection inductance element.
